(19) United States
(12) Patent Application Publication
(10) Pub. No.: US 2002/0144269 A1
(43) Pub. Date: Oct. 3, 2002

(54) Apparatus and method for a dynamic electronic program guide enabling billing broadcast services per EPG line item

(76) Inventor: Jay H. Connelly, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/823,566

(22) Filed: Mar. 30, 2001

(51) Int. Cl. G06F 3/00; H04N 5/445; G06F 13/00

(52) U.S. Cl. 725/49; 725/48

(57) ABSTRACT

An apparatus and method for a dynamic electronic program guide enabling billing broadcast services per EPG line items are described. The method includes the receipt of content information from one or more cached content service providers for each content item stored on a client system. Once the content information is received, line items are allocated, from the electronic program guide, to the one or more cached content service providers. Next, the content information is merged for display in the electronic program guide. Finally, the one or more cached content service providers are charged a predetermined amount for each allocated line item. The allocation of line items includes allocation of a line item for each stored content item, for each genre grouping of stored content and a line item for each cached content service provider. As such, the present invention enables an EPG owner to derive additional revenue by charging caching services for access via the EPG.

### FIELD OF THE INVENTION

The invention relates generally to the field of electronic program guides (EPG). More particularly, the invention relates to a method and apparatus for a dynamic electronic program guide enabling billing broadcast services per EPG line item.

### BACKGROUND OF THE INVENTION

Broadcast systems traditionally transmit data in one direction, from a server system to a plurality of client systems. For instance, cable television providers commonly broadcast the same movies repeatedly on multiple channels at staggered intervals. As such, users of the client systems typically consume the signal received from the server as they are broadcast. However, such broadcast systems generally have a capability to generate additional revenues by broadcasting content, which is offered to users at a predetermined fee, which is normally referred to as viewing on a pay-per-view basis.

Digital broadcast networks (whether satellite, cable or terrestrial) make use of service information to announce the availability of, and parameters for content. Typically, these announcements are consumed by the receiver's electronic program guide (EPG) and are used to present and acquire programming. In this environment, streaming content as well as premium content (e.g., Pay-Per-View, HBO, etc.) may be scattered across the spectrum presented by the EPG. These existing electronic program guides are currently controlled by either the broadcast service (as is the case for Echostar, DirecTV, AT&T, . . ., etc.), or are controlled by the personal video recorder (PVR) manufacturers (such as TiVo and Replay). In either case, the entire electronic program guide is controlled by a single service, offering access to streaming content, such as pay-per-view movies, subscription movies, and additional content.

However, as multiple data broadcasting/cached content services begin to show up on client platforms or set-top boxes, cached content broadcast by these multiple broadcast services will generally not be incorporated into the network service information and inaccessible via the EPG. Consequently, user access, via the EPG, to additional broadcast content provided by the multiple broadcasting services is crucial. Without access via the EPG, multiple broadcasting services will be unable to generate pay-per-view revenue for viewing of the additional broadcast content. From the perspective of the broadcast service, the benefit is to have one or more EPG lines that enable a consumer to access their programs directly from the EPG. In other words, a user should access the additional broadcast/cached content just as the user would access streaming content broadcast by a standard broadcast service.

Therefore, there remains a need to overcome one or more of the limitations in the above-described, existing art.

### BRIEF DESCRIPTION OF THE DRAWINGS

The present invention is illustrated by way of example and not limitation in the accompanying figures.

FIG. 1 depicts a block diagram illustrating a broadcast service system as known in the art.

FIG. 2A depicts a block diagram illustrating a digital broadcasting/cached content service provider system in accordance with one embodiment of the present invention.

FIG. 2B depicts a block diagram illustrating a digital broadcasting/cached content service provider system in accordance with a further embodiment of the present invention.

FIG. 3 depicts a block diagram illustrating a computer system representative of a client or a server in accordance with an embodiment of the present invention.

FIG. 4 depicts a block diagram illustrating a digital broadcasting/cached content service provider system in accordance with an exemplary embodiment of the present invention.

FIGS. 5A, 5B and 5C depict block diagrams illustrating a dynamic electronic program guide (EPG) enabling billing broadcast services per EPG line item in accordance with an embodiment of the present invention.

FIG. 6 depicts a flow diagram illustrating the flow of events in a client for implementing a dynamic electronic program guide enabling billing broadcast services per EPG line item in accordance with an embodiment of the present invention.

FIG. 7 is a flow diagram illustrating the flow of additional events performed by a client for generating a dynamic electronic program guide enabling billing broadcast services per EPG line item in accordance with the further embodiment of the present invention.

FIG. 8 is a flow diagram illustrating additional events performed by a client when assigning EPG line items to one or more broadcast services in accordance with a further embodiment of the present invention.

FIG. 9 depicts a flow diagram illustrating additional events performed by a client when assigning EPG line items to one or more broadcast services in accordance with the further embodiment of the present invention.

### DETAILED DESCRIPTION

The present invention describes an apparatus and method for a dynamic electronic program guide enabling billing broadcast services per EPG line item. In particular, the present invention describes a method and apparatus that enables EPG owners to derive additional revenues by charging digital broadcasting/cached content service provider systems for access via the EPG. In the following description, for the purposes of explanation, numerous specific details are set forth in order to provide a thorough understanding of the present invention. It will be apparent, however, to one skilled in the art that the present invention may be practiced without some of these specific details. In addition, the following description provides examples, and the accompanying drawings show various examples for the purposes of illustration. However, these examples should not be construed in a limiting sense as they are merely intended to provide examples of the present invention rather than to provide an exhaustive list of all possible implementations of the present invention. In other instances, well-known structures and devices are shown in block diagram form in order to avoid obscuring the details of the present invention.

In an embodiment, the methods of the present invention are embodied in machine-executable instructions. The instructions can be used to cause a general-purpose or special-purpose processor that is programmed with the instructions to perform the steps of the present invention. Alternatively, the steps of the present invention might be performed by specific hardware components that contain hardwired logic for performing the steps, or by any combination of programmed computer components and custom hardware components.

The present invention may be provided as a computer program product which may include a machine-readable medium having stored thereon instructions which may be used to program a computer (or other electronic devices) to perform a process according to the present invention. The machine-readable medium may include, but is not limited to, floppy diskettes, optical disks, Computer Disc, Read-Only Memory (CD-ROMs), and magneto-optical disks, Read-Only Memory (ROMs), Random Access Memory (RAMs), Erasable Programmable Read-Only Memory, (EPROMs), Electrically Erasable Programmable Read-Only Memory (EEPROMs), magnetic or optical cards, flash memory, or other type of media / machine-readable medium suitable for storing electronic instructions. Moreover, the present invention may also be downloaded as a computer program product. As such, the program may be transferred from a remote computer (e.g., a server) to a requesting computer (e.g., a client) by way of data signals embodied in a carrier wave or other propagation medium via a communication link (e.g., a modem or network connection).

System Architecture

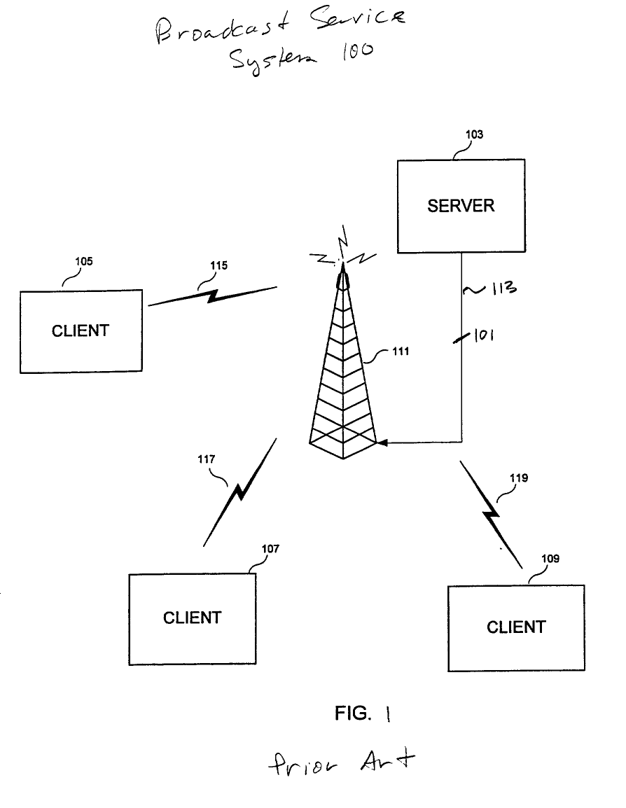

FIG. 1 is an illustration of one embodiment of a conventional broadcast service system 100, as known to those skilled in the art. The broadcast service system 100 includes a server 103 configured to broadcast information 101 to a plurality of clients 105, 107 and 109. Client 105 receives a broadcast from server 103 through a link 115 from a broadcast antenna 111. Similarly, client 107 receives a broadcast from server 103 through a link 117 and client 109 receives a broadcast from server 103 through a link 119 from broadcast antenna 111.

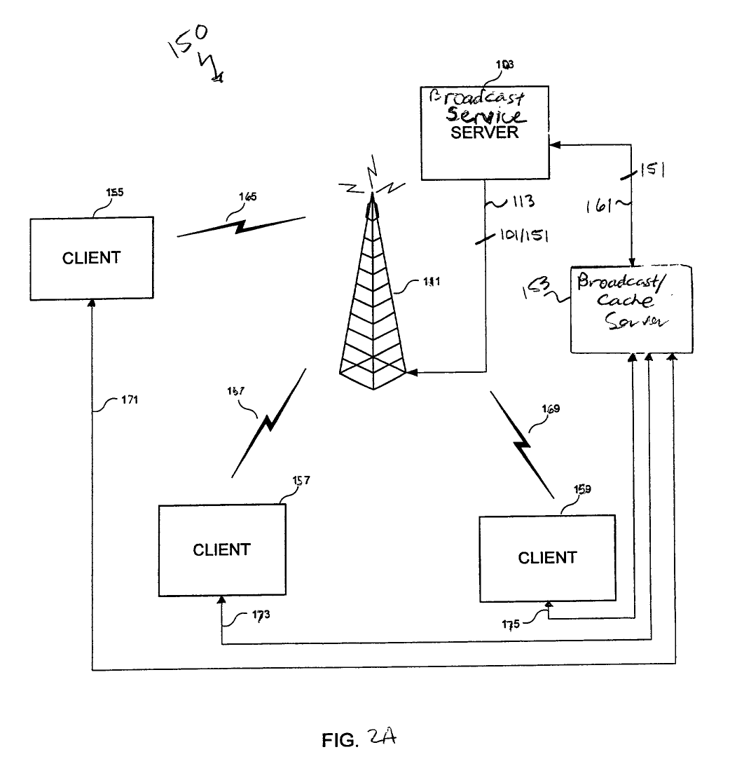

Referring now to FIG. 2A, a digital broadcast/cached content service provider system (“broadcast/cache system”) 150 is depicted. The broadcast/cache system 150 is designed to work in conjunction with a standard broadcast system, such as the broadcast service system 100, as depicted in FIG. 1. As will be described in further detail below, the broadcast/cache system 150 enables companies or broadcast systems who want to optimize pay-per view or subscription royalties to combine their existing broadcast content with a digital broadcasting/caching service provided by the broadcast/cache system.

The broadcast/cache system 150, as depicted in FIG. 2A, is configured to broadcast information 151 to a plurality of clients 155, 157 and 159, for example, utilizing bandwidth provided by the broadcast service system 100. As such, the broadcast/cache system 150 transmits the information 151 to the broadcast server 103. The information 151 along with the broadcast information 101 is then broadcast, via antenna 111, to the plurality of clients 155, 157 and 159. However, those skilled in the art will appreciate that the broadcast of information, as contemplated by the present invention, includes broadcast via cable, satellite, broadcast antenna, or the like, as described in further detail below. Client 155 receives a broadcast from the broadcast server 103 through a link 165 from a broadcast antenna 111. Similarly, client 157 receives a broadcast from the broadcast server 103 through a link 167 and client 159 receives a broadcast from broadcast server 103 through a link 169 from broadcast antenna 111. In this embodiment, links 165, 167 and 169 are uni-direction, wireless radio frequency (RF links) from broadcast antenna 111. The format of such broadcasts is, for example but not limited to, known amplitude modification (AM) or frequency modification (FM) radio signals, television (TV) signals, digital video broadcasts (DVB) signals, or the like, which are broadcast through the atmosphere.

The broadcast server 103 is configured to broadcast a plurality of broadcast data files 101, which may be received by clients 155, 157 and 159. In addition, the broadcast server 103 allocates bandwidth to the broadcast/cache server 153 in order to broadcast a plurality of provider data files 151, which are also received by clients 155, 157 and 159. The data files 101/151 may include, for example, any combination of a number of different types of files including for example video, audio, graphics, text, multi-media or the like. For purposes of explanation, many of the examples provided in this disclosure to help describe the present invention assume that the data files to be broadcast by the server are audio/video files, such as for example movies with moving images and sound. However, it will be appreciated that the data files broadcast in accordance with the teachings of the present invention are not limited only to audio/video files.

FIG. 2B is an illustration of a further embodiment of the broadcast/cache system 170 in accordance with the teachings of the present invention. As shown, the broadcast/cache server 153 utilizes bandwidth provided by the broadcast server 103 to broadcast information 151 to a plurality of clients 155, 157 and 159 through a network 163. In one embodiment, network 163 may be any type of communications network through which a plurality of different devices may communicate such as for example but not limited to the Internet, a wide area network (WAN), a local area network (LAN), an Intranet, an Extranet or the like.

In the embodiment illustrated in FIG. 2B, client 165 receives information 101/151 broadcast from broadcast server 103 through link 155. Similarly, client 157 receives information 101/151 broadcast from broadcast server 103 through link 167 and client 159 receives information 101/151 broadcast from the broadcast server 153 through link 169. It is noted that in the embodiment illustrated in FIG. 2B, links 165, 167 and 169 are shown as unidirectional links from network 163 to clients 155, 157 and 159, in which a back channel, as depicted in FIG. 2A, may be used to communicate information to the service provider server 153. In another embodiment, links 165, 167 and 169 are bidirectional links, which enable clients 155, 157 and 159 to communication information to the service provider server 153.

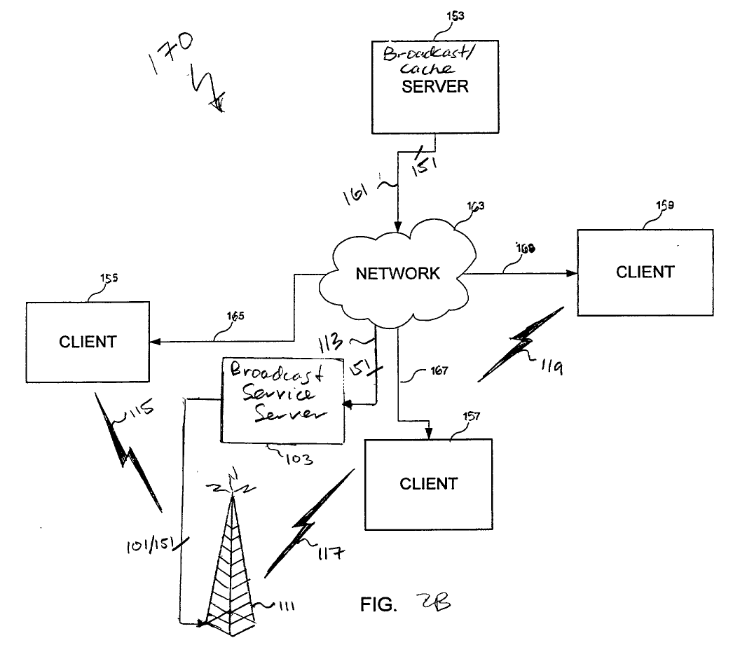

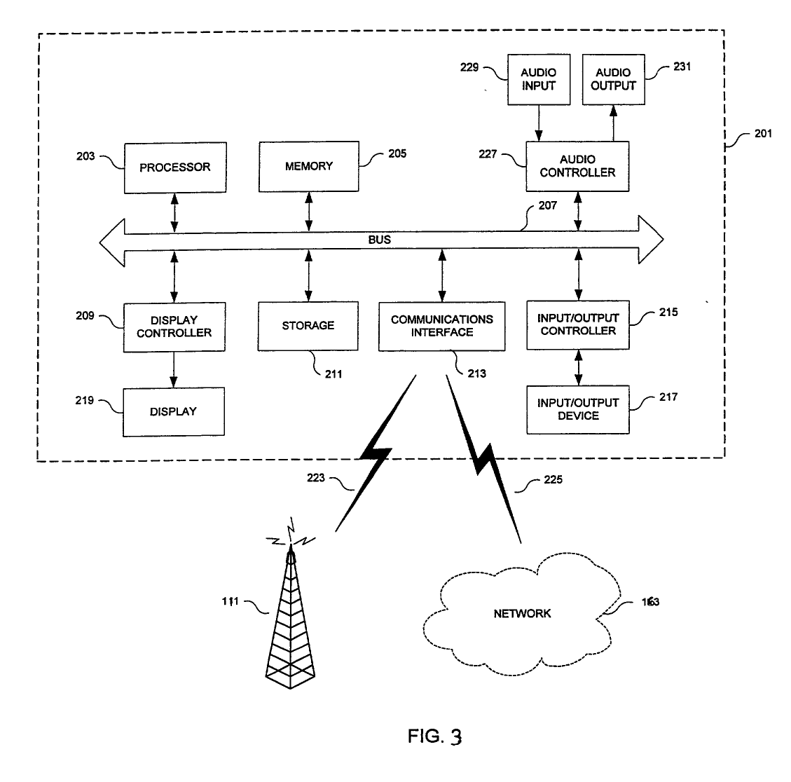

FIG. 3 is a block diagram illustrating one embodiment of a machine 201 that may be used for the service provider server 153, or clients 153, 155 or 157 in accordance with the teachings of the present invention. The machine 201 is, for example, a computer or a set top box that includes a processor 203 coupled to a bus 207. The machine 201 includes a memory 205, a storage 211, a display controller 209, a communications interface 213, an input/output controller 215 and an audio controller 227 are also coupled to bus 207.

In one embodiment, machine 201 interfaces to external systems through communications interface 213. Communications interface 213 may include, for example, a radio transceiver compatible with AM, FM, TV, digital TV, DVB, wireless telephone signals or the like. Communications interface 213 may also include, for example, an analog modem, Integrated Services Digital Network (ISDN) modem, cable modem, Digital Subscriber Line (DSL) modem, a T-1 line interface, a T-3 line interface, an optical carrier interface (e.g. OC-3), token ring interface, satellite transmission interface, a wireless interface or other interfaces for coupling a device to other devices.

A carrier wave signal 223 may be received by communications interface 213 to communicate with antenna 111. In addition, a carrier wave signal 225 may be received/transmitted between communications interface 213 and network 113. The carrier wave signal 225 may also be used to interface machine 201 with another computer system, a network hub, router or the like. The carrier wave signals 223 and 225 are, for example, considered to be machine readable media, which may be transmitted through wires, cables, optical fibers or through the atmosphere, or the like.

The processor 203 may be a conventional microprocessor, such as, for example, but not limited to an Intel x86 or Pentium family microprocessor, a Motorola family microprocessor, or the like. Memory 205 may be a machine readable medium such as dynamic random access memory (DRAM) and may include static random access memory (SRAM). Display controller 209 controls, in a conventional manner, a display 219, which may be a cathode ray tube (CRT), a liquid crystal display (LCD), an active matrix display, a television monitor or the like. The input/output device 217 coupled to input/output controller 215 may be, for example, a keyboard, disk drive, printer, scanner and other input and output devices, including a television remote, mouse, trackball, trackpad, joystick, or the like. In one embodiment, audio controller 227 controls in a conventional manner audio output 231, which may include for example audio speakers, headphones, an audio receiver, amplifier or the like. In addition, the audio controller may also control, in a conventional manner, audio input 229, which may include for example a microphone or input(s) from an audio or musical device, or the like.

The storage 211 may, for example, include machine readable media such as for example but not limited to a magnetic hard disk, a floppy disk, an optical disk, a smart card or another form of storage for data. Alternatively, the storage 211 may include, for example, removable media, read-only media, readable/writable media or the like. Some of the data may, for example, be written by a direct memory access process into memory 205 during execution of software in computer system 201. It is appreciated that software may reside in storage 211, memory 205 or may be transmitted or received via modem or communications interface 213. For the purposes of the specification, the term “machine readable medium” shall be taken to include any medium that is capable of storing data, information or encoding a sequence of instructions for execution by processor 203 to cause processor 203 to perform the methodologies of the present invention. The term “machine readable medium” shall be taken to include, but is not limited to solid-state memories, optical and magnetic disks, carrier wave signals, and the like.

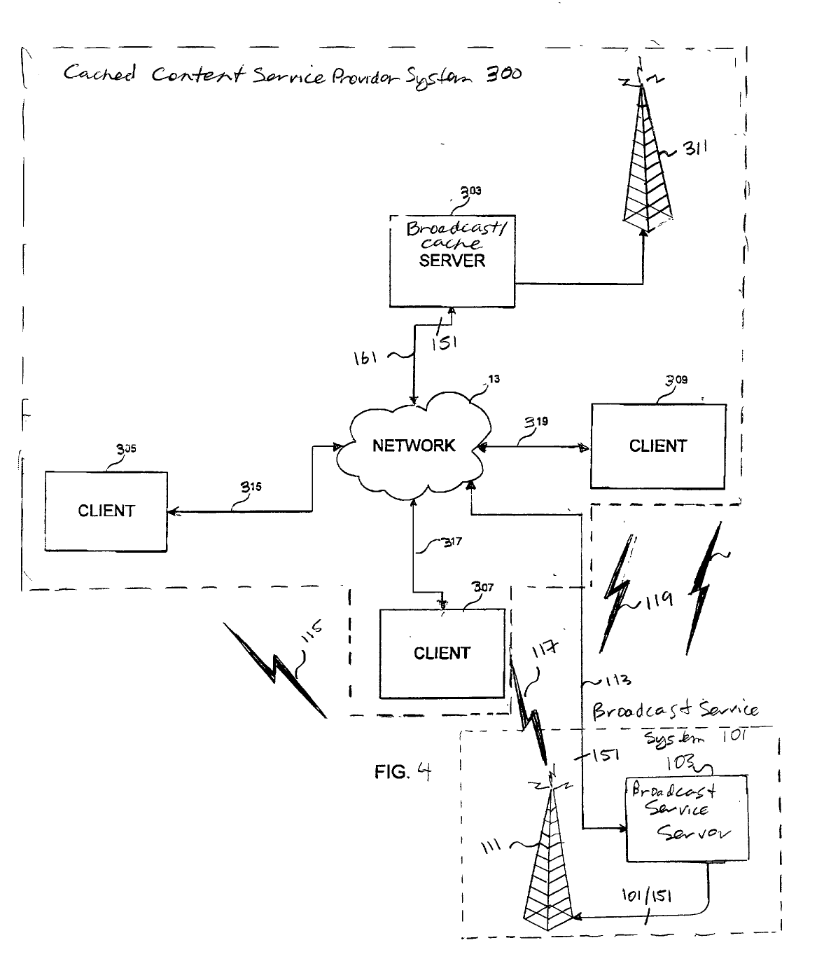

Referring now to FIG. 4, one embodiment of a digital broadcasting/cached content service provider system (broadcast/cache system) 300, such as for example one similar to the broadcast systems depicted in FIGS. 2A and 2B, is depicted. The broadcast/cache system 300 is configured to have a broadcast/cache server 303 broadcast a plurality of provider data files 151 to a plurality of clients 305, 307 and 309 utilizing bandwidth provided by a broadcast server 103. The broadcast/cache system 300 utilizes content 101 broadcast by a broadcast service system, such as the broadcast service system 100 depicted in FIG. 1, in order to generate a plurality of provider data files 151 broadcast to the clients 305, 307 and 309.

As referred herein, a digital broadcasting/cached content service provider describes a broadcast system wherein the system selects one or more data files to broadcast to a client system based on feedback generated by the client system in response to user access of stored data files. Once the one or more data files are selected, the data files are broadcast to one or more client systems, which store the one or more data files. The data files are stored by the client systems in order to enable viewing at a later date and time by a user. This digital broadcasting/caching service is provided by the service provider broadcast system 300 as depicted in FIG. 4.

In one embodiment, data files may be stored locally by the client in, for example, memory 205, storage 211 or in a locally accessible network by machine 201 of FIG. 3. For purposes of this disclosure, data files being stored locally by the client may also be interpreted to include a data filed stored “locally” by the client in a known network storage configuration, separate from the server. For purposes of this disclosure, the data file being stored or cached locally by the client is to be interpreted as the data file being stored for later access, retrieval or consumption. In one embodiment, the local cache of the present invention is considered to be a first level cache. Thus, the local cache of the present invention is sized accordingly to increase the possibility of a single hit.

Referring back to the continuing example of data files representing audio/video files, a movie is stored locally by the client. After a user watches the movie, the storage space occupied by the movie is generally considered to be available for storage of another movie to be broadcast sometime later. If a user has not watched a particular movie, the storage space occupied by that movie is generally considered not to be available for storage of another movie. However, if there is no additional storage space available and a higher rated movie is to be broadcast, the lower rated unwatched movie is replaced by the higher rated movie in accordance with the teachings of the present invention.

However, the broadcast/cache system 300 can be utilized to broadcast content in conjunction with the broadcast service system 100 as depicted in FIGS. 1 and 4. Consequently, content selected by the service provider broadcast system 300, in response to client rankings, is transmitted to one or more client systems using bandwidth provided by the broadcast service system 100. However, in order to best utilize bandwidth provided by the broadcast service system 100, the broadcast/cache system 300 generates the combined meta-data set in order to receive rankings for a plurality of data files available from the broadcast/cache system 300, as well as the broadcast data files 101. The broadcast/cache system 300 will select a subset of the plurality of data files from the broadcast data files 101 to form a provider/broadcast data file subset.

The data files stored by the one or more clients 305, 307, 309 are stored to enable viewing by a user at a later date and time. In one embodiment, the user is charged or billed in order to view the stored data files, which is commonly referred to as viewing on a pay per-view basis. Alternatively, the user may be charged a subscription fee for viewing stored content data files. As described herein, the terms pay-per-view and subscription viewing are used interchangeably. However, in order to access stored data files and enable pay per-view viewing of these data files by the user, the stored data files are most conveniently accessed via the electronic programming guide currently existing on the client system. Unfortunately, existing electronic program guides are currently controlled by either the service provider (as is the case for Echostar, DirecTV, AT&T, . . ., etc.) or controlled by the personal video recorder (PVR)manufacturers (such as TiVo and Replay). In either of these cases, the electronic programming guide is controlled by a single service offering access to streaming content such as pay-per-view movies, subscription movies and additional content.

However, as multiple data broadcasting services begin to appear, such as the digital broadcast/cached content service provider system 300, as depicted in FIG. 4, the company which controls the EPG is in a prime position to make additional revenues by renting out line items. For example, to broadcast/cached content systems 300, access to cached content, via the existing EPG, is essential for enabling pay per-view or subscription viewing of cached content. As such, EPG owners may derive additional revenue by charging such cached content service providers for access to the cached content via the EPG.

The amount of money charged to such cached content service providers is generally proportional to the number of EPG line items needed. The cost of adding EPG line items to the EPG owner is one of opportunity and cost. Consequently, if everyone who wants a line is allowed to add lines at will, then the EPG becomes too cumbersome to manage and fails to meet feasibility goals. From the cached service providers' perspective, the benefit of having an EPG line is that the consumer can access the stored data files and data directly from the EPG just the same as they would for a streaming content or the broadcast data files, which are repeatedly broadcast by broadcast systems such as broadcast service system 100 depicted in FIGS. 1 and 4.

In other words, EPG line items are at a premium for cached content service providers. Moreover, each cached content service provider should be able to choose how its content is presented in the EPG. Consequently, the EPG manufacturer is in a position to generate revenue by selling virtual channels to each cached content service provider, as well as the standard broadcast service systems, such as depicted in FIGS. 1 and 4. For example, in the case of streaming content (such as HBO, Showtime, Cinemax, or Pay-Per-View presentations), the content is described as a series of movies that are going to be broadcast over one or more channels. However, as content broadcast by one or more cached content service providers is stored in the client platform, an EPG that displays only the streaming content is no longer sufficient. Consequently, some mechanism must be devised to allow the EPG manufacturer to generate additional revenues by selling virtual channels to access the stored content data files. In addition, such a system should enable a user to find and purchase the stored content while simultaneously allowing the cached content service provider to advertise the available content and generate additional pay-per-view or subscription revenues.

Referring now to FIG. 5, the display 219 of the machine 201, as depicted in FIG. 3, is illustrated. In one embodiment, the machine 209 is configured as a set-top box with the display 219 provided by a standard television. The display 219 includes a dynamic electronic program guide for enabling the billing of broadcast/cached content service providers per EPG line item. However, the manner for displaying the cached content or stored data files of the client systems may vary. As such, the cached content service providers have to decide the best mechanism to present their content on the EPG. On one hand, a cached content service provider may desire to place each content item in the EPG. In this case, they should be charged for all the clutter they create. For example, referring to FIG. 5A, the electronic program guide 400 would include a line item for each stored data file. As such, channel 400 would contain the movie “The Terminator”, while channel 401 would contain “Steel Magnolias” and channel 402 would contain “When Harry Met Sally”.

Referring now to FIG. 5B, in another instance, the cached content service provider may decide to organize groups of similar content to provide a higher level view into the content. As such, the electronic program guide 430 would include channel 400 containing action movies, channel 401 containing tear-jerkers, and channel 402 containing comedies. Still, a third option would be for the caching service to present a single entry in the EPG 460, which vectors all deeper content requests directly to the service, for example, as depicted in FIG. 5C.

Referring now to FIG. 5C, channel 400 would contain a reference to the cached content service provider (“Rainier Movie Service”). As such, the user could access the EPG 460 and be vectored to the various movies available from the Rainier Movie Service. Procedural methods for performing the teachings of the present invention are now described.

Operation

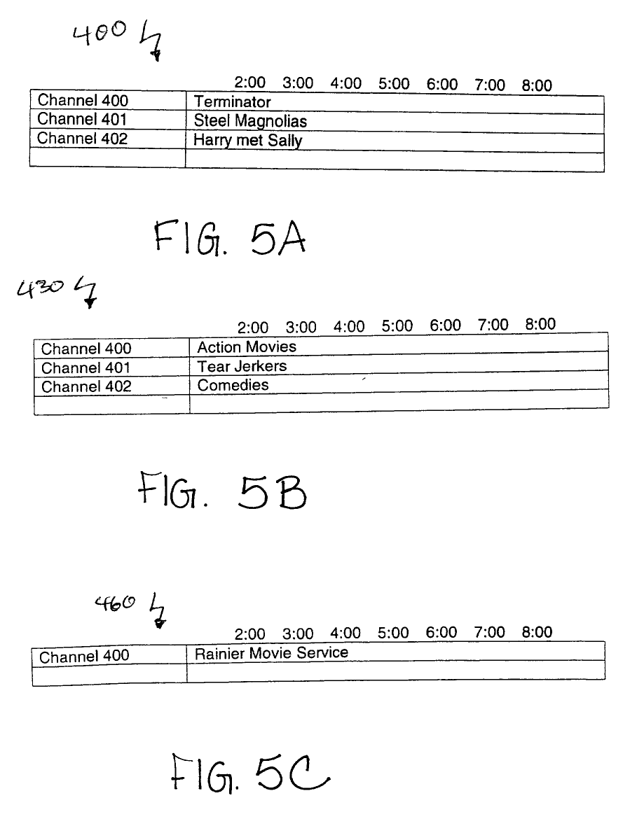

Referring now to FIG. 6, FIG. 6 depicts a flow chart illustrating the flow of events 500 performed by a client of a digital broadcast/cached content service provider system, for example as depicted in FIGS. 3 and 4. The flow of events depicted in FIG. 6 illustrate implementation of a dynamic electronic program guide for enabling billing of digital broadcast/cached content service providers per EPG line item. At process block 502, the client receives content information from one or more cached content service providers for each content data files stored/cached by the client. At process block 504, the client allocates line items in an electronic program guide to the one or more cached content service providers. At process block 530, the client merges the content information for display in the electronic program guide. Finally, at process block 540, the one or more cached content service providers are charged a predetermined amount for each allocated line item. The predetermined amount is generally negotiated with each of the one or more cached content service providers. As such, each cached content service provided may be charged a different predetermined amount per EPG line item.

Referring now to FIG. 7, a flow chart is depicted illustrating additional flow of events 506 in a client system for allocating line items in an electronic program guide. At process block 508, a line item is assigned for each content data file stored/cached in the client system. Finally, at process block 510, a line item is generated in the electronic program guide for each stored content data file. For example, referring again to FIG. 5A, process blocks 508 and 510 illustrate an embodiment where the electronic program guide will include a line item for each content data file stored in the client system.

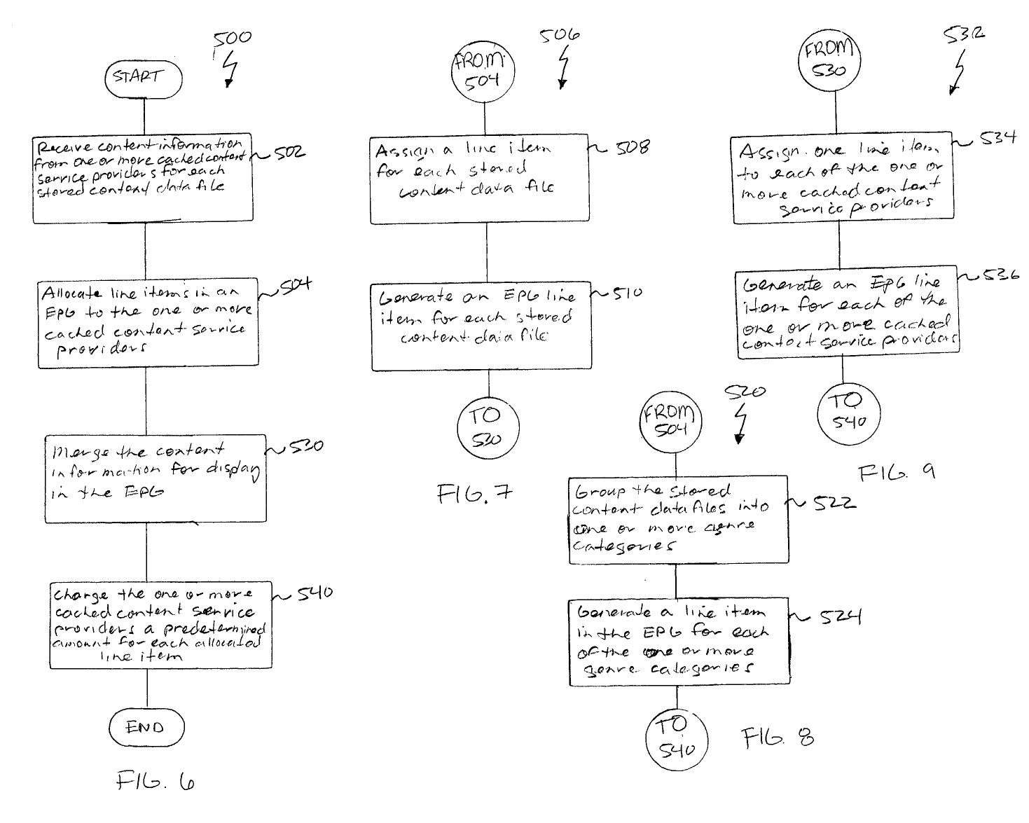

Referring now to FIG. 8, a flow chart is illustrated depicting the flow of events 520 performed by a client system when allocating line items in an electronic program guide. At process block 522, stored content data files are grouped into one or more categories, such as, for example, genre categories. At step 524, a line item is generated in the electronic program guide for each of the one or more categories. For example, referring once again to FIG. 5B, process blocks 522 and 524 illustrate steps for grouping stored content data files in the client systems into one or more genre categories.

Referring now to FIG. 9, a flow chart is illustrated depicting additional flow of events 532 for allocating line items in the electronic program guide. At process block 534, one line item is assigned to each of the one or more cached content service providers. At process block 536, a line item is generated in the electronic program guide for each cached content service provider. For example, referring once again to FIG. 5C, process blocks 534 and 536 illustrate an embodiment wherein each cached content service provider is allocated a single line item in the electronic programming guide.

Alternate Embodiments

Several aspects of one implementation of a dynamic electronic program guide enabling billing cached content service providers per EPG line item have been described. However, various implementations of the dynamic electronic program guide provide numerous features including, complementing, supplementing, and/or replacing the features described above. Features can be implemented as part of the server or as part of the user's computer system in different implementations. In addition, the foregoing description, for purposes of explanation, used specific nomenclature to provide a thorough understanding of the invention. However, it will be apparent to one skilled in the art that the specific details are not required in order to practice the invention.

In addition, although an embodiment described herein is directed to an electronic program guide, it will be appreciated by those skilled in the art that the teaching of the present invention can be applied to other systems. In fact, systems for access to stored content items, including motion pictures, music files, video games, computer media or the like, are within the teachings of the present invention, without departing from the scope and spirit of the present invention. The embodiments described above were chosen and described in order to best explain the principles of the invention and its practical applications. These embodiment were chosen to thereby enable others skilled in the art to best utilize the invention and various embodiments with various modifications as are suited to the particular use contemplated.

It is to be understood that even though numerous characteristics and advantages of various embodiments of the present invention have been set forth in the foregoing description, together with details of the structure and function of various embodiment of the invention, this disclosure is illustrative only. In some cases, certain subassemblies are only described in detail with one such embodiment. Nevertheless, it is recognized and intended that such subassemblies may be used in other embodiments of the invention. Changes may be made in detail, especially matters of structure and management of parts within the principles of the present invention to the full extent indicated by the broad general meaning of the terms in which the appended claims are expressed.

The present invention provides many advantages over known techniques. The present invention includes the ability to enable cached content service providers to determine the allocation of line items in an electronic program guide. For example, each service can determine the financial trade-offs required to receive an EPG entry. The services can compare and contrast different schemes and make a decision on which one has the higher return of investment for that service. In addition, the owners of the electronic program guide can derive additional revenue. From an EPG owner's standpoint, the present invention allows the EPG owner to receive additional revenue for each additional service supported on the set top box. Finally, the market can determine the correct mix of EPG line items. Rather than relying on an EPG manufacturer to determine which cached entries receive line items and rather than allowing just the cached content service providers to determine which items are displayed, the present invention describes a mechanism which enables the market to decide. For example, if the amount of clutter in the EPG gets too high, users will complain and the EPG manufacturer can respond with higher prices, thereby cutting down the clutter. However, if access to the cached content are hard to find, users will complain and the EPG manufacturer may be forced to lower prices for generating EPG line items so as to provide better access.

Having disclosed exemplary embodiments and the best mode, modifications and variations may be made to the disclosed embodiments while remaining within the scope of the invention as defined by the following claims.

What is claimed is:

1. A method comprising:
receiving content information from one or more cached content service providers for each stored content data file;
allocating line items in an electronic program guide to the one or more cached content service providers;
merging the content information for display in the electronic program guide; and
charging each of the one or more cached content service providers a predetermined amount for each allocated line item.

2. The method of claim 1, wherein the allocating the line items further comprises:
assigning a line item for each stored content data file; and
generating an electronic program guide line item for each stored content data file.

3. The method of claim 1, wherein the allocating the line items further comprises:
grouping the stored content data file into one or more categories; and
generating a line item in the electronic program guide for each of the one or more categories.

4. The method of claim 1, wherein the allocating the line items further comprises:
assigning one line item to each of the one or more cached content service providers; and
generating an electronic program guide line item for each of the one or more cached content service provider.

5. The method of claim 1, wherein the stored content data files are one of a movie, a music file, a video game and computer media.

6. The method of claim 1, further comprising:
negotiating a predetermined amount to charge a cached content service provider per electronic program guide line item; and
repeating the negotiating the predetermined amount for each of the one or more cached content service providers.

7. A computer readable storage medium including program instructions that direct a computer to function in the specified manner when executed by a processor, the program instructions comprise:
receiving content information from one or more cached content service providers for each stored content data file;
allocating line items in an electronic program guide to the one or more cached content service providers;
merging the content information for display in the electronic program guide; and
charging each of the one or more cached content service providers a predetermined amount for each allocated line item.

8. The computer readable storage medium of claim 7, wherein the program instruction of allocating the line items further comprises:
assigning a line item for each stored content data file; and
generating an electronic program guide line item for each stored content data file.

9. The computer readable storage medium of claim 7, wherein the program instructions of allocating the line items further comprises:
grouping the stored content data files into one or more categories; and
generating a line item in the electronic program guide for each of the one or more categories.

10. The computer readable storage medium of claim 7, wherein the program instructions of allocating the line items further comprises:
assigning one line item to each of the one or more cached content service providers; and
generating an electronic program guide line item for each of the one or more cached content service provider.

11. The computer readable storage medium of claim 7, wherein the stored content data files are one of a movie, a music file, a video game and computer media.

12. The computer readable storage medium of claim 7, wherein the program instructions further comprise:
negotiating a predetermined amount to charge a cached content service provider per electronic program guide line item; and
repeating the negotiating the predetermined amount for each of the one or more cached content service providers.

13. An apparatus, comprising:
a processor having circuitry to execute instructions;
a communications interface coupled to the processor, the communications interface to broadcast data to one or more client systems, and to receive data from the one or more client systems;
a display device;
a storage device coupled to the processor, having sequences of instructions stored therein, which when executed by the processor cause the processor to:
receive content information from one or more cached content service providers for each stored content data file,
allocate line items in an electronic program guide to the one or more cached content service providers,
merge the content information for display in the electronic program guide via the display device, and
charge each of the one or more cached content service providers a predetermined amount for each allocated line item.

14. The apparatus of claim 13, wherein the instruction to allocate the line item further causes the processor to:
assign a line item for each stored content data file; and
generate an electronic program guide line item for each stored content data file.

15. The apparatus of claim 13, wherein the instruction to allocate the line item further causes the processor to:
group the stored content data files into one or more categories; and
generate a line item in the electronic program guide for each of the one or more categories.

16. The apparatus of claim 13, wherein the instruction to allocation the line item further causes the processor to:
assign one line item to each of the one or more cached content service providers; and
generate an electronic program guide line item for each of the one or more cached content service providers.

17. The apparatus of claim 13, wherein the stored content data files are one of a movie, a music file, a video game and computer media.

18. The apparatus of claim 13, wherein the processor is further caused to:
negotiate a predetermined amount to charge a cached content service provider per electronic program guide line item; and
repeat the negotiating the predetermined amount for each of the one or more cached content service providers.
